(19) United States
(12) Patent Application Publication
(10) Pub. No.: US 2013/0171377 A1
(43) Pub. Date: Jul. 4, 2013

(54) Artificial Stone Laminate

(71) Applicant: Gosakan Aravamudan, Bangalore (IN)

(72) Inventor: Gosakan Aravamudan, Bangalore (IN)

(21) Appl. No.: 13/820,751

(22) PCT Filed: Sep. 2, 2011
(86) PCT No.: PCT/IN2011/000602

§ 371 Date: Mar. 5, 2013

(30) Foreign Application Priority Data
Sep. 6, 2010 (IN) 2575/CHE/2010

(51) Int. Cl. B44F 9/04; B44C 5/04

(52) U.S. Cl. CPC B44F 9/04; B44C 5/04
USPC 428/15; 156/62.2

(57) ABSTRACT

An artificial stone laminate including a layer of particulates, a layer of reinforcing fibers backing the layer of particulates, a substrate attachment layer backing the layer of reinforcing fibers, and a binder that binds the particulates, the reinforcing fibers, and the substrate attachment layer is provided. An exposed surface of the layer of particulates is polished flat. The reinforcing fibers include, for example, glass fibers. The substrate attachment layer is, for example, a cellulosic layer, a layer of cenospheres, a layer of fleece, or a layer having a hook side or a loop side of a hook and loop fastener. The binder is, for example, a polyester resin with a filler or an acrylic resin. The particulates include, for example, one or more of quartz particulates, metal pieces, transparent particulates coated with metal and colored glass, or any combination thereof.

### CROSS REFERENCE TO RELATED APPLICATIONS

This application claims the benefit of the following patent applications:
1. Provisional patent application number 2575/CHE/2010 titled “Quartz Composite”, filed on 6 Sep. 2010 in the Indian Patent Office.
2. PCT application number PCT/IN2011/000602 titled “Artificial Stone Laminate” filed on 2 Sep. 2011 in the Indian Patent Office.

The specifications of the above referenced applications are incorporated herein by reference in their entirety.

### BACKGROUND

This invention, in general, relates to building structures. More particularly, this invention relates to an architectural surface for furniture and building structures.

Currently, decorative laminates and wood veneers are extensively used as architectural surfaces. In most cases, decorative laminates are manufactured from kraft paper impregnated with phenolic resin. Wood and its derivatives are currently the preferred choice of material for surfacing furniture and building structures.

Decorative laminates show scratches over prolonged use, and uncoated wood veneers absorb moisture and stain easily. If proper care is not taken, wood products have a limited life. Wood products may decay when exposed to moisture for long periods, and are prone to termite attacks. In tropical countries with excess rainfall, wood expands seasonally due to excess moisture content. As a result, doors and windows surfaced with wood or its derivatives get jammed within their frames.

Engineered stone is currently manufactured in various thicknesses, for example, a thickness of about 12 millimeters (mm). Such engineered stone is not currently used as a thin architectural surface laminate, for example, in laminate applications such as surfacing on wooden boards. There is a need for architectural laminates having a thickness of approximately 1 mm to 3 mm. There is also a need for improving adhesion between the architectural laminate and its substrate. Typical adhesives, for example, common wood glues cannot be used to adhere a resin containing surface of an architectural laminate to a wood plank. Therefore, there is a need for improving adhesion between the laminate and its substrate. Moreover, there is a need for decorative laminates that remain intact and provide good visual appearances even when exposed to moisture or other external environmental conditions.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The artificial stone laminate disclosed herein overcomes the drawbacks of wood derived architectural surfaces. The artificial stone laminate disclosed herein has a very high abrasion resistance and is waterproof. Hence, the artificial stone laminate disclosed herein remains intact even with prolonged exposure to environmental conditions while retaining the aesthetic appearance for a considerable period of time.

The artificial stone laminate disclosed herein comprises a layer of particulates, a layer of reinforcing fibers backing the layer of particulates, a substrate attachment layer backing the layer of reinforcing fibers, and a binder that binds the particulates, the reinforcing fibers, and the substrate attachment layer. The exposed surface of the layer of particulates is polished flat. In an embodiment, the size of the particulates is selected, for example, between about 0.5 mm and about 3 mm. In another embodiment, the particulates are of varying sizes. The particulates comprise, for example, one or more of quartz particulates, metal pieces, transparent particulates coated with metal and colored glass, or any combination thereof. The reinforcing fibers comprise, for example, glass fibers. In an embodiment, the binder is a polyester resin with a filler. In another embodiment, the binder is an acrylic resin.

In an embodiment, the substrate attachment layer is a cellulosic layer, for example, a thin wood slice of thickness less than about 0.5 mm. The cellulosic layer may also comprise paper made from wood fibers. The cellulosic layer of the artificial stone laminate disclosed herein allows attachment to wood surfaces. Commonly available wood adhesives that bond wood to wood can be used to attach the artificial stone laminate to another wood surface.

In another embodiment, the substrate attachment layer is a layer of cenospheres or glass microspheres. The layer of cenospheres of the artificial stone laminate disclosed herein allows attachment of the artificial stone laminate to cement surfaces, for example, using a cementitious bonding agent that is compatible with both cement and the cenospheres.

In another embodiment, the substrate attachment layer comprises a hook side or a loop side of a hook and loop fastener. The hook side and the loop side of the hook and loop fastener is attached to opposing surfaces to be fastened. For example, if the hook side of the hook and loop fastener is attached to the artificial stone laminate, the loop side of the hook and loop fastener is attached to an external surface where the artificial stone laminate is to be fastened, and vice versa. When the hook side and the loop side of the hook and loop fastener are pressed together, the hooks on the hook side catch in the loops on the loop side for attaching the artificial stone laminate to the external surface. In another embodiment, the substrate attachment layer is a layer of fleece.

Disclosed herein is a method for manufacturing an artificial stone laminate. The method disclosed herein comprises the following steps: A layer of particulates is spread on a release surface. The layer of particulates is vibrated. The vibration of the layer of particulates causes the particulates to be packed closely, to touch one another adjacently in a horizontal plane, and to achieve high surface coverage. A layer of reinforcing fibers is placed on the layer of particulates. A substrate attachment layer is placed on the layer of reinforcing fibers. A binder is introduced for binding the particulates, the reinforcing fibers, and the substrate attachment layer. The binder is introduced to bind all the components of the artificial stone laminate. In an embodiment, a surface of the substrate attachment layer is chemically modified for improving adhesion of the substrate attachment layer with the rest of the artificial stone laminate. An exposed surface of the layer of particulates is polished. Furthermore, the method disclosed herein comprises application of vacuum and pressure to the binder, the layer of particulates, the layer of reinforcing fibers, and the substrate attachment layer during and/or after the introduction of the binder.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 exemplarily illustrates an artificial stone laminate comprising a cellulosic layer.

FIG. 2 exemplarily illustrates an artificial stone laminate comprising a layer of cenospheres.

FIG. 3 exemplarily illustrates an artificial stone laminate comprising a hook and loop fastener as an attachment layer.

FIG. 4 illustrates a method for manufacturing an artificial stone laminate.

### DETAILED DESCRIPTION OF THE INVENTION

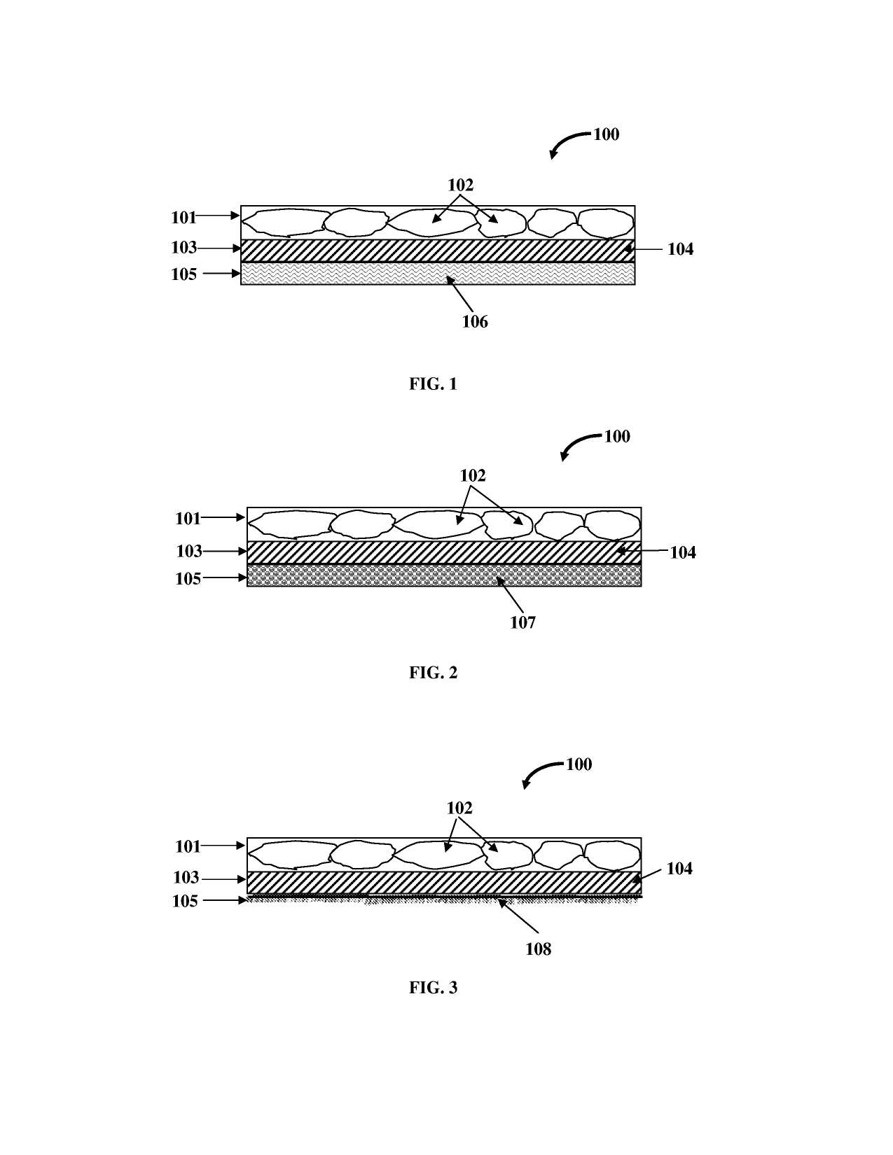

The artificial stone laminate 100 exemplarily illustrated in FIGS. 1-3 is, for example, a decorative laminate comprising a visually decorative and functional surface covering. Decorative laminates are required to be thin and flexible to be used as an architectural surface covering, as heavier and thicker decorative laminates pose difficulty in adhering to substrates. Thicker and heavier decorative laminates may delaminate and warp over time. The artificial stone laminate 100 disclosed herein comprises a layer 101 of particulates 102 that is lightweight and visually appealing. Furthermore, since the artificial stone laminate 100 disclosed herein comprises a thin layer 101 of particulates 102, there is substantial reduction, for example, in cost, thickness, and weight resulting in a thin lightweight artificial stone laminate 100. The higher exposed top flat surface area of the particulates 102 of the artificial stone laminate 100 provides a greater visual decorative appeal. Furthermore, the higher exposed top flat surface area of the particulates 102, for example, quartz particulates results in greater abrasion resistance and stain resistance.

The artificial stone laminate 100 disclosed herein further comprises a layer 103 of reinforcing fibers 104 backing the layer 101 of particulates 102, a substrate attachment layer 105 backing the layer 103 of reinforcing fibers 104, and a binder that binds the particulates 102, the reinforcing fibers 104, and the substrate attachment layer 105 as disclosed in the detailed description of FIGS. 1-3. The substrate attachment layer 105 provides an adhesive compatible surface for attachment of the artificial stone laminate 100 to other surfaces. As disclosed in the detailed description of FIG. 1, the substrate attachment layer 105 is a cellulosic layer 106. As disclosed in the detailed description of FIG. 2, the substrate attachment layer 105 is a layer of cenospheres 107. As disclosed in detailed description of FIG. 3, the substrate attachment layer 105 comprises a hook side or a loop side of a hook and loop fastener 108.

FIG. 1 exemplarily illustrates an artificial stone laminate 100 comprising a cellulosic layer 106. As exemplarily illustrated in FIG. 1, the artificial stone laminate 100 disclosed herein comprises a top layer 101 of particulates 102. An exposed surface of the layer 101 of particulates 102 is polished flat. A mid layer 103 of reinforcing fibers 104 backs the layer 101 of particulates 102. A substrate attachment layer 105 backs the layer 103 of reinforcing fibers 104. In an embodiment as exemplarily illustrated in FIG. 1, the substrate attachment layer 105 is a cellulosic layer 106. The cellulosic layer 106 is, for example, a thin wood slice, veneer, or wood face sheet of thickness less than about 0.5 millimeters (mm). The cellulosic layer 106 may also comprise paper made from wood fibers. The cellulosic layer 106 allows attachment of the artificial stone laminate 100 to wood surfaces using wood compatible adhesives. In an embodiment, a surface of the cellulosic layer 106 is chemically modified for improving adhesion of the cellulosic layer 106 with the rest of the artificial stone laminate 100. For example, a surface of the cellulosic layer 106 is chemically modified by treating the surface of the cellulosic layer 106 with a hydroxymethylated resorcinol (HMR) based priming agent for improving adhesion of the cellulosic layer 106 with the rest of the artificial stone laminate 100. The commonly available adhesives that bond wood to wood can also be used to stick the artificial stone laminate 100 to another wood surface via the cellulosic layer 106. A binder binds the particulates 102, the reinforcing fibers 104, and the cellulosic layer 106. In an embodiment, the binder is, for example, a polyester resin with a filler. In another embodiment, the binder is an acrylic resin. The binder may have a high concentration of a solid filler, for example, aluminum trihydrate.

FIG. 2 exemplarily illustrates an artificial stone laminate 100 comprising a layer of cenospheres 107. The artificial stone laminate 100 disclosed herein comprises a top layer 101 of particulates 102, a mid layer 103 of reinforcing fibers 104 backing the layer 101 of particulates 102, and a substrate attachment layer 105 backing the layer 103 of reinforcing fibers 104 as disclosed in the detailed description of FIG. 1. In an embodiment, the substrate attachment layer 105 is a layer of cenospheres 107 herein referred to as a “cenosphere attachment layer”. As used herein, the term “cenosphere” refers to a lightweight, hollow sphere filled with inert air or gas, typically produced as a byproduct of coal combustion at thermal power plants. The thin cenosphere attachment layer 107 of the artificial stone laminate 100 disclosed herein allows attachment of the artificial stone laminate 100 to cement surfaces using, for example, a cementitious bonding agent that is compatible with both cement and the cenospheres 107. The cenosphere attachment layer 107 may also be replaced with a thin layer of glass spheres.

In another embodiment, the substrate attachment layer 105 is a layer of fleece. Fleece is a soft napped insulating synthetic fabric made from polyethylene terephthalate (PET) or other synthetic fibers. The layer of fleece allows attachment of the artificial stone laminate 100 to surfaces.

FIG. 3 exemplarily illustrates an artificial stone laminate 100 comprising a hook and loop fastener 108 as an attachment layer. The artificial stone laminate 100 disclosed herein comprises a top layer 101 of particulates 102, a mid layer 103 of reinforcing fibers 104 backing the layer 101 of particulates 102, and a substrate attachment layer 105 backing the layer 103 of reinforcing fibers 104 as disclosed in the detailed description of FIG. 1. In an embodiment, the substrate attachment layer 105 comprises a hook side or a loop side of a hook and loop fastener 108. The hook and loop fastener 108 is, for example, a Velcro® fabric hook and loop fastener of Velcro Industries B.V. LLC. The hook side and the loop side of the hook and loop fastener 108 is attached to opposing surfaces to be fastened. For example, if the hook side of the hook and loop fastener 108 is attached to the layer 103 of reinforcing fibers 104 of the artificial stone laminate 100, the loop side of the hook and loop fastener 108 is attached to an external surface where the artificial stone laminate 100 is to be fastened, and vice versa. When the hook side and the loop side of the hook and loop fastener 108 are pressed together, the hooks on the hook side catch in the loops on the loop side for attaching the artificial stone laminate 100 to the external surface. The artificial stone laminate 100 can be separated from the external surface, by pulling or peeling the hook side and the loop side of the hook and loop fastener 108 apart. The hook and loop fastener 108 enables the artificial stone laminate 100 to be detachably attached to any external surface or structure.

In an embodiment, particulates 102 of varying sizes are selected, for example, between about 0.5 mm and about 3 mm. In another embodiment, the size of the particulates 102 is selected, for example, in the range of about 1.05 mm to about 1.95 mm. In this case, the size deviation of the particulates 102 from the single size of the particulates 102 is restricted to plus or minus 40%. For example, within this range, a substantially single size of the particulates 102 selected is approximately 1.5 mm. In case the selected size of the particulates 102 is 1.5 mm, the maximum particulates 102 size ranges is plus or minus 40%, that is, the actual size of the particulates 102 is in the range of 0.9 mm to 2.1 mm.

The particulates 102 comprise, for example, quartz particulates, or one or more of quartz particulates, metal pieces, transparent particulates coated with metal and colored glass, or any combination thereof. In an embodiment, the particulates 102 are transparent quartz particulates. The particulates 102 further comprise, for example, metal or pigment coated quartz or glass particulates that provide improved reflective or colored aesthetics. The particulates 102 further comprise, for example, colored glass particulates that create artistic patterns or designs on the surface of the artificial stone laminate 100. In the end product, the exposed surface of the layer 101 of particulates 102 is a polished surface.

The transparency of quartz particulates 102 gives the exposed top flat surface area of the layer 101 of quartz particulates 102 a rich visual appearance. Furthermore, quartz particulates 102 provide exceptional scratch resistance. In addition to the quartz particulates 102, other particulates, for example, glass particulates, ceramic particulates, or stone particulates may also be added on the exposed top flat surface area of the artificial stone laminate 100. The addition of the other particulates to the quartz particulates 102 results, for example, in improved aesthetic qualities.

The reinforcing fibers 104 comprise, for example, glass fibers. The layer 103 of reinforcing fibers 104 is, for example, a chopped strand mat, or comprises woven fibers or knitted fibers. The layer 103 of reinforcing fibers 104 comprises, for example, one or more of glass fibers, polyester fibers, ceramic fibers, carbon fibers, aramid fibers, organic fibers, etc.

Consider an example where a three dimensionally knitted glass fiber layer of thickness greater than about 2 mm is overlaid on and then bonded to a layer 101 of quartz particulates 102 or glass particulates 102. The size of the loop of the knitted glass fiber layer may be greater than the size of the quartz particulates 102 or the glass particulates 102. The coarse surface of the knitted glass fiber layer as well as the cavities between the knits allows for exceptional adhesion between the knitted glass fiber layer and the quartz particulates 102.

In an embodiment, a lightweight core is provided as a backing to the substrate attachment layer 105. The lightweight core is, for example, polyurethane foam, a honeycomb structure, wood, etc. The honeycomb is, for example, a paper honeycomb, a reinforced plastic honeycomb, a plastic honeycomb, an aluminum honeycomb, etc.

The binder used for filling gaps between the particulates 102 and for binding the reinforcing fibers 104 to the particulates 102 is, for example, a thermoset plastic such as a polyester resin, along with a filler. For example, a polyester resin is a combination of orthothalic neo pentyl glycol and styrene, or a combination of isophthalic neo pentyl glycol, methyl methyl acrylate, and styrene. Room temperature catalysts, for example, methyl ethyl ketone peroxide (MEKP) and room temperature accelerators may be used along with the binder for curing the binder. High temperature setting catalysts, for example, benzoyl peroxide (BPO) may also be used for curing the binder. The filler is a fine powder, for example, aluminum trihydrate, calcium carbonate, quartz powder, or a combination of the compounds mentioned thereof, etc. The use of aluminum trihydrate as a filler makes the artificial stone laminate 100 disclosed herein fire resistant.

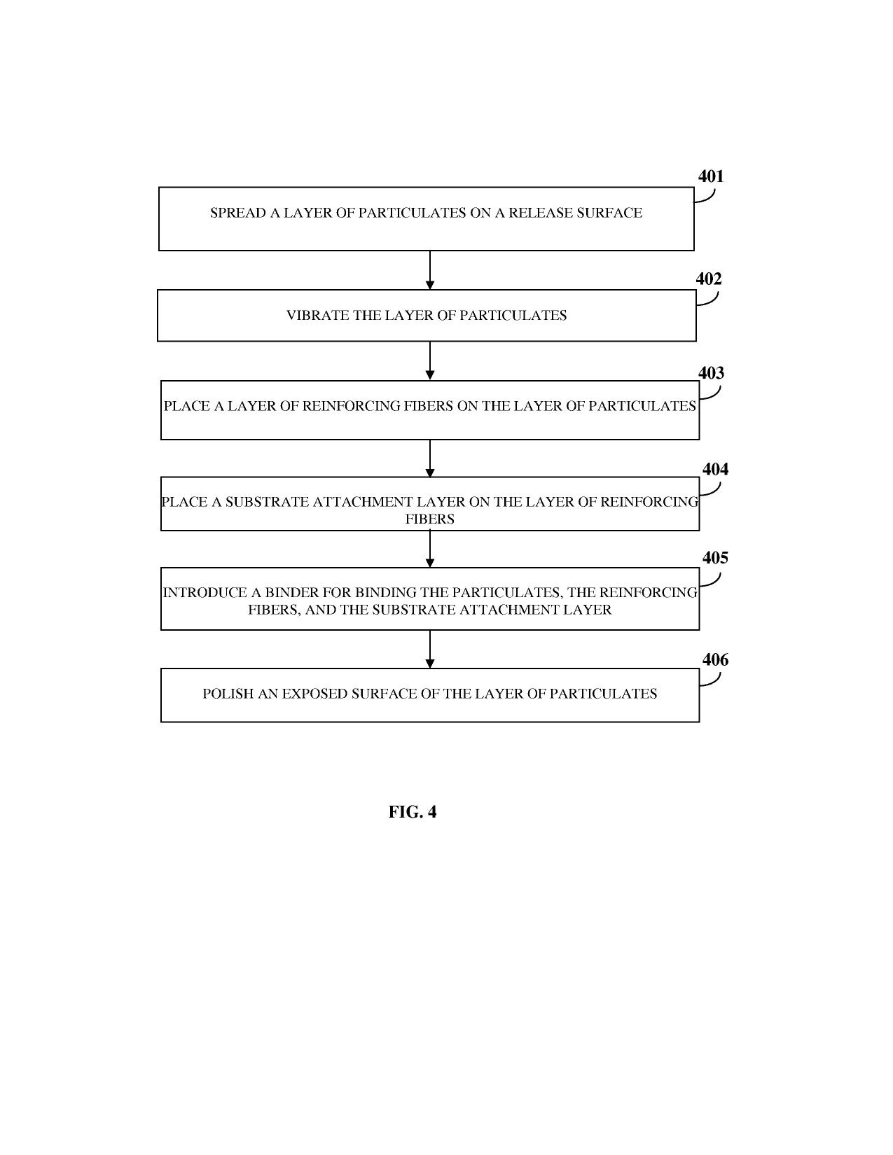

FIG. 4 illustrates a method for manufacturing an artificial stone laminate 100 exemplarily illustrated in FIGS. 1-3. The method disclosed herein comprises the following steps. A layer 101 of particulates 102 is spread 401 on a release surface. The release surface is, for example, one of a silicon rubber sheet, a Teflon® sheet of E. I. du Pont de Nemours and Company, a Mylar® sheet of E. I. du Pont de Nemours and Company, etc. In an embodiment, the release surface is treated with release coatings, for example, polyvinyl alcohol or silicone sprays. The layer 101 of particulates 102 on the release surface is vibrated 402. The vibration of the layer 101 of particulates 102 causes the particulates 102 to pack closely, touch one another adjacently in a horizontal plane, and achieve high surface coverage. A layer 103 of reinforcing fibers 104 is placed 403 on the layer 101 of particulates 102. A substrate attachment layer 105, for example, a cellulosic layer 106 as exemplarily illustrated in FIG. 1, or a cenosphere attachment layer 107 as exemplarily illustrated in FIG. 2, a layer of fleece, or a hook side or a loop side of a hook and loop fastener 108 as exemplarily illustrated in FIG. 3, is placed 404 on the layer 103 of reinforcing fibers 104. A binder is introduced 405 into the layers 101, 103, and 105 of the artificial stone laminate 100. The binder binds the particulates 102, the reinforcing fibers 104, and the substrate attachment layer 105. The binder is introduced, for example, by one of the processes of resin transfer molding, tape casting, pressure extrusion, spraying, etc. After the binder cures, an exposed surface of the layer 101 of the particulates 102 is polished 406. In an embodiment, the method disclosed herein further comprises application of vacuum and pressure to the binder, the layer 101 of particulates 102, the layer 103 of reinforcing fibers 104, and the substrate attachment layer 105 during and/or after the introduction of the binder. The application of vacuum and/or pressure eliminates formation of air bubbles in the artificial stone laminate 100. The surface of the layer 101 of particulates 102 may be chemically modified, for example, with a silane coupling agent for improving adhesion of the particulates 102 with the binder. The surface of the substrate attachment layer 105 may be chemically modified for improving adhesion of the substrate attachment layer 105 with the binder.

In an embodiment, decorative material may be embedded within the layer 101 of particulates 102, for example, a layer of quartz particulates. The decorative material comprises, for example, one or more of ornamental glass, a quartz composite, semiprecious stones, metal art, colored quartz, glass or stone jewelry, etc. The decorative material is placed on a release surface, for example, on a Teflon® release sheet of E. I. du Pont de Nemours and Company. The decorative material, for example, large quartz particulates 102 are deposited on the Teflon® release sheet. The large quartz particulates 102 may be treated with an organofunctional coupling agent for better adhesion between the large quartz particulates 102, and the binder and the reinforcing fibers 104. The binder is, for example, a polyester resin. The organofunctional coupling agent is, for example, an organofunctional silane. The release surface is vibrated whereby the large quartz particulates 102 are packed closely and achieve high surface coverage. The binder, for example, the polyester resin is deposited with a high concentration of solid filler. The binder fills the gaps between the large quartz particulates 102. A layer 103 of reinforcing fibers 104 is placed on the layer 101 of quartz particulates 102, wherein the binder binds the reinforcing fibers 104 to the layer 101 of large quartz particulates 102. The surface of the layer 101 of large quartz particulates 102 is polished along with the decorative material after the binder cures.

The artificial stone laminate 100 disclosed herein is thin, flexible, and lightweight and is used as an architectural surfacing material. Examples of the application of the artificial stone laminate 100 disclosed herein comprise the surfacing of kitchen countertops, wall claddings, doors, tabletops, wardrobes, shelves, work-tops, counters, wall linings, column claddings, storage units, lift linings, store fittings, displays, vanity units, cubicles, check out desks, office partitions, and other home and office furniture.

The following example illustrates a method for manufacturing the artificial stone laminate 100 disclosed herein and the composition of the artificial stone laminate 100. A mix of particulates 102 of substantially a single size with the size of the mix of the particulates 102 ranging, for example, between about 1.4 mm to about 1.6 mm is deposited on a release surface, for example, a silicone rubber sheet of size 4 feet×8 feet placed on a metal work bench. The particulates 102 comprise, for example, 80% by weight of transparent quartz, 19% by weight of colored glass chips, and 1% by weight of aluminum coated glass chips. The aluminum coated glass chips provide a reflective shine to the artificial stone laminate 100. A layer 101 of particulates 102 is deposited on the silicone rubber sheet placed on the metal work bench and the metal work bench is gently vibrated, for example, with an asymmetrically loaded shaft of a motor until the particulates 102 are packed together, and touch one another adjacently. Vertical overlap of the particulates 102 is avoided as the vertical overlap of the particulates 102 would undesirably result in a thicker and uneven section of the artificial stone laminate 100. A layer 103 of reinforcing fibers 104, for example, a chopped strand mat of density 900 grams per square meter is placed on the layer 101 of particulates 102. A substrate attachment layer 105, for example, a 0.2 mm thin wood veneer is placed on the chopped strand mat. A binder comprising, for example, isothalic neo pentyl glycol polyester resin, styrene, 3% by weight of a black pigment, 2% by weight of a methyl ethyl ketone peroxide (MEKP) catalyst, and 0.2% by weight of dimethyl aniline (DMA) is deposited on the particulates 102 by either spraying or resin transfer molding. Vacuum is applied to the above layers 101, 103, and 105 and the binder of the resulting composite by enveloping the particulates 102, the binder, and the reinforcing fibers 104 in a vacuum bag. After the mix cures, the cured composite is polished, for example, using diamond polishing bricks. This results in an artificial stone laminate 100 of an approximate thickness of, for example, about 1.5 mm.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. An artificial stone laminate, comprising:
a layer of particulates, wherein an exposed surface of said layer of said particulates is polished flat;
a layer of reinforcing fibers backing said layer of said particulates;
a substrate attachment layer backing said layer of said reinforcing fibers; and
a binder binding said particulates, said reinforcing fibers, and said substrate attachment layer.

2. The artificial stone laminate of claim 1, wherein said substrate attachment layer is a cellulosic layer.

3. The artificial stone laminate of claim 1, wherein said substrate attachment layer is a layer of cenospheres.

4. The artificial stone laminate of claim 1, wherein said substrate attachment layer comprises one of a hook side and a loop side of a hook and loop fastener.

5. The artificial stone laminate of claim 1, wherein said substrate attachment layer is a layer of fleece.

6. The artificial stone laminate of claim 1, wherein size of said particulates is selected between about 0.5 millimeters and about 3 millimeters.

7. The artificial stone laminate of claim 1, wherein said binder is a polyester resin with a filler.

8. The artificial stone laminate of claim 1, wherein said binder is an acrylic resin.

9. The artificial stone laminate of claim 1, wherein said reinforcing fibers comprise glass fibers.

10. The artificial stone laminate of claim 1, wherein said particulates comprise quartz particulates.

11. The artificial stone laminate of claim 1, wherein said particulates comprise one or more of quartz particulates, metal pieces, transparent particulates coated with metal and colored glass, and any combination thereof.

12. A method for manufacturing an artificial stone laminate, comprising:
spreading a layer of particulates on a release surface;
vibrating said layer of said particulates, wherein said vibration of said layer of said particulates causes said particulates to be packed closely, to touch one another adjacently in a horizontal plane, and to achieve high surface coverage;
placing a layer of reinforcing fibers on said layer of said particulates;
placing a substrate attachment layer on said layer of said reinforcing fibers;
introducing a binder for binding said particulates, said reinforcing fibers, and said substrate attachment layer; and
polishing an exposed surface of said layer of said particulates.

13. The method of claim 12, wherein said substrate attachment layer is a cellulosic layer.

14. The method of claim 12, wherein said substrate attachment layer is a layer of cenospheres.

15. The method of claim 12, wherein said substrate attachment layer comprises one of a hook side and a loop side of a hook and loop fastener.

16. The method of claim 12, wherein said substrate attachment layer is a layer of fleece.

17. The method of claim 12, further comprising applying vacuum and pressure to said binder, said layer of said particulates, said layer of reinforcing fibers, and said substrate attachment layer during and/or after said introduction of said binder.

18. The method of claim 12, further comprising chemically modifying a surface of said substrate attachment layer for improving adhesion of said substrate attachment layer with said binder.
